(19) United States
(12) Patent Application Publication
(10) Pub. No.: US 2026/0083141 A1
(43) Pub. Date: Mar. 26, 2026

(54) EDIBLE TREATMENT COMPOSITION FOR SHELF-LIFE EXTENSION OF MUSHROOMS

(71) Applicant: NAVORK INNOVATIONS PRIVATE LIMITED, New Delhi (IN)

(72) Inventors: Abhishek Sahgal, New Delhi (IN); Karel Affan Zahoor, Raigad (IN)

(21) Appl. No.: 19/109,178

(22) PCT Filed: Sep. 6, 2023
(86) PCT No.: PCT/IN2023/050841

§ 371 Date: Mar. 6, 2025

(30) Foreign Application Priority Data
Sep. 6, 2022 (IN) 202211050703

(51) Int. Cl. A23B 2/771; A23B 2/754; A23B 2/762

(52) U.S. Cl. CPC A23B 2/771; A23B 2/754; A23B 2/762

(57) ABSTRACT

The present invention discloses an edible treatment composition comprising non-toxic and non-hazardous chemicals to extend the shelf-life and maintain freshness of mushroom for prolonged time during its storage and shipment. The disclosed edible treatment composition includes Kojic Acid, L-arginine, Hydroxycinnamic acid (HCA) and optionally additional active or inactive components like antimicrobial agent, etc. This invention is concerned with the treatment of mushroom with disclosed edible treatment composition, pre- or post-harvest, to extend its shelf-life by imparting one or more properties like, maintained whiteness, delayed browning, delated pileus (cap) opening, better firmness, maintained structural integrity, slower weight-loss, etc. for prolonged time, amongst others.

### BACKGROUND

### Technical Field

The embodiments herein generally relate to a composition for treatment of fresh mushrooms, more particularly, to an edible treatment composition for extending shelf-life and maintaining freshness of mushrooms for prolonged time.

### Description of the Related Art

Owing to its unique flavour and rich nutritional composition, mushroom is a very important crop in national as well as international markets. Mushrooms are fungi with open fruit body having very tender cap surface without a significant outer protective structure—epidermis. Mushrooms naturally have very short shelf-life due to their high water content and high metabolic activity which brings about fast deterioration of mushroom indicated by mushroom colour browning, blotch formation, pileus (cap) opening, electrolytic leakage, cell wall lignification, autolysis and microbial degradation, etc. The four main factors responsible for low shelf-life and poor appearance of mushroom with time are: high respiration rate, enzymatic browning, moisture loss and microbial infestation. Mushrooms have a very high respiration rate compared to other fruits that can be stored for longer period of time having low respiration rates; which causes it to use up its carbohydrates and age faster. Mushroom body does not possess an epidermis, hence undergoes a rapid water loss which translates into weight loss and poor shrivelled appearance with time. Mushrooms have very high levels of a copper containing enzyme called Tyrosinase or Polyphenol Oxidase (PPO) having mixed functions. Postharvest browning in mushrooms is mainly due to Tyrosinase, which is responsible for oxidation of phenols into quinone with subsequent polymerization and browning. Mushrooms have very thin and weak cell walls which can break easily on physical impact like touch; undergoing cellular decompartmentalization and PPO enzyme leakage which binds with proteins to induce browning. Microbial infestation is another major factor that limits the shelf-life of mushrooms. A variety of bacteria may bring about yellow to dark brown discolouration on mushroom caps, which is known as blotch. Blotch is one of the most widespread disease in mushroom which may lead to produce yield loss by affecting the quality of mushroom, both pre- and post-harvest.

Deterioration of mushroom quality due to above mentioned factors during storage and transport of mushrooms causes its nutritional, commercial and commodity value to be lost. This also leads to concentration of fresh mushroom in markets near the mushroom farm leading to more-supply-than-demand and thus a sharp fall in prices, seriously compromising the interest of mushroom producers. On the other hand, in the areas far from mushroom production base, a supply-less-than-demand scenario is created, at the same time.

Currently, the advancement of mushroom shelf-life extension technologies in India and abroad is not adequately profound. Cold storage, ozone treatment, modified atmosphere packaging, irradiation, use of chemical agents, etc. are common methods being employed currently for the purpose. The respiration rate of mushroom and hence its enzymatic reaction rate is reduced by lowering the surrounding temperature in cold storage technique. Despite being one of the most classical techniques employed for shelf-life extension of mushrooms, cold storage requires huge investments in return for considerably short storage period extension; hence return on investment is inconsiderable. Ozone treatment is one of the methods used to inactivate microorganisms present on mushroom by placing mushroom in high density ozone environment. Ozone treatment, though takes care of microbial infestation, causes mushroom to lose its sensory qualities on treatment. Also, ozone is potentially toxic for throat and nasal cavity when inhaled. Modified atmosphere packaging (MAP) helps in mushroom shelf-life extension by partly controlling its respiration rate. While Modified Atmosphere Packaging (MAP) has some potential to extend shelf-life of mushroom, except for some microbes, it does not eliminate harmful bacteria. Also, MAP is a sophisticated approach that requires special equipment and training leading to added cost. Irradiation technique is employed such that mushrooms are exposed to radiant energy from high-energy electron beam and y rays-post-harvest. It proves to be effective against broad spectrum of bacteria and fungi at high doses. But at high doses, irradiation is known to cause accelerated senescence and/or sensory defects. Also, irradiation technique requires intensive capital investment, and is not properly regulated. Lately, more focus is diverted towards use of chemical treatment for extension of mushroom shelf-life.

Traditionally, sulfite solution dipping treatment has been done on mushrooms to make them visibly whiter and clean unwanted debris. However, FDA prohibited use of sulfite compounds on mushroom in 1986, after consumers with asthma started experiencing allergic reactions in response to exposure to such compounds. Also, sulfite solution treated mushroom exhibited short term benefit of whiteness that lasted for a single day after harvest and couldn't protect mushroom against microbial attack for longer.

Following the ban on Sulfite, McConnell in year 1991 developed a water based dipping solution for mushroom treatment; containing Hydrogen peroxide (H₂O₂) functioning as anti-bacterial agent and Calcium disodium Ethylene diamine tetraacetic acid (EDTA) that further facilitates bactericidal effect of H₂O₂ along with reducing the mushroom browning activity by chelating with copper. McConnell's formulation was further modified by Sapers in 1994 into a two-step, rather laborious, process. Step 1 involved treatment of mushroom with H₂O₂ followed by its treatment with a combination of cysteine, erythorbate and Ethylene diamine tetraacetic acid in the step 2.

High pH levels are known to have a bactericidal effect, especially on gram negative bacteria like Pseudomonas, that are predominantly found on mushrooms. Beelman and Duncan devised a two-step process in 1999 that included washing of mushroom with a high pH solution as antimicrobial treatment followed by treatment with Calcium, Sodium erythorbate and Ethylene diamine tetraacetic acid as enzymatic-browning retarding agents. Different chemical treatment processes developed in the prior art have their own

limitations. Most of these processes involve multiple steps in mushroom treatment. Not much of sophistication is advanced in mushroom industry, hence most of the tasks like watering, harvest, packaging and logistics are undertaken using bare hands; thus multi-step process leads to increased probability of physical/mechanical damage to mushroom tissue and increased susceptibility to microbial infestation, in-turn leading to its brown discolouration and low shelf-life. The methods in prior-art have a very restricted variety in raw materials and are limited to certain specific chemical classes and chemicals within a class, most of which are too costly to be commercially accepted. The treatment approach used on mushroom in prior-art is mostly post-harvest dipping treatment in an aqueous composition, which is associated with excessive water intake by mushrooms. From past research knowledge, water is known to play a crucial role in vulnerability of mushroom degradation. Even though this approach removes debris adhering to mushroom surface, dipping treatment may accelerate blotch development or browning as a result of water absorption leading to high internal humidity and mechanical injury to mushroom surface. Mushrooms with excess water content lose organoleptic properties more quickly than unwashed mushrooms. In prior-art high pH wash solution is used as antimicrobial agent to destroy bacteria. Even though it acts as anti-bacterial agent, high pH may cause direct tissue damage to mushrooms. At times, mushroom infestation by pathogens is hard to manifest until it has been harvested and packed-which along with solitary degradation affects the surrounding mushrooms, thus rendering entire pack commercially useless. Certain chemicals used in the prior-art are known to be environmentally unsafe and toxic, storage and handling of which may be extremely dangerous for unskilled workers.

While there has been advancement in science of mushroom treatment and shelf-life extension techniques over the years, there has not been known previously any single method that would take care of all the different factors responsible for mushroom degradation and its low shelf-life-which includes its internal activities and external factors. Consequently, it would be highly desirable to develop a solution, incorporating chemicals safe for human consumption, that would address different internal and external factors responsible for low shelf-life of mushroom.

### SUMMARY

The present invention discloses a treatment composition to extend the shelf-life and maintain freshness of mushrooms. Accordingly, described herein is a simple, edible and versatile treatment composition comprising of chemicals safe for human consumption to increase shelf-life of fresh mushrooms.

In some embodiments, the edible treatment composition provides extension of shelf-life of the one or more mushrooms by addressing one or more factors including enzymatic browning, high respiration rate, microbial infestation that are responsible for high degradation rate and low shelf-life of mushrooms. For example, treatment with this edible treatment composition addresses at least one factor responsible for low shelf-life of mushroom.

In some embodiments, the edible treatment composition provides increase in shelf-life of mushroom by delaying mushroom yellowing and browning. The edible treatment composition preferably includes an anti-yellowing and anti-browning agent, more specifically Kojic acid.

In another embodiment, the edible treatment composition provides increase in shelf-life of mushroom by effectively controlling tissue softening, maintaining tissue firmness and thus preventing electrolyte leakage in mushrooms. The edible treatment composition preferably includes an active agent responsible for effectively controlling tissue softening, maintaining tissue firmness and preventing electrolyte leakage in mushroom, more specifically L-arginine.

In yet another embodiment, the edible treatment composition provides increase in shelf-life of mushroom by delaying mushroom ageing and pileus (cap) opening. The treatment composition preferably includes an anti-ageing agent, more specifically Hydroxycinnamic acid (HCA).

In an aspect, an embodiment herein provides an edible treatment composition for shelf-life extension of one or more mushrooms up to at least 3 days. The edible treatment composition includes Kojic Acid in a range between about 0.001% (w/w) and about 0.1% (w/w) that functions as anti-yellowing and anti-browning agent, HCA in a range of between about 0.0001% (w/w) and about 0.01% (w/w) that functions as anti-ageing agent, and L-arginine in a range between about 0.0002% (w/w) and about 0.02% (w/w) that is responsible for tissue firmness and preventing electrolyte leakage. The edible treatment composition including a mixture of Kojic acid, HCA, and L-arginine is applied on the one or more mushrooms by any of dipping, drenching, spraying, misting, or brushing the edible treatment composition over the one or more mushrooms, that facilitates shelf-life extension of the one or more mushrooms up to at least 3 days.

In some embodiments, the Kojic acid is obtained from any of soy sauce, rice wine, fungal species of Aspergillus, or any of its other natural or synthetic sources, in the form of Kojic acid or its derivatives, as isolated chemical compounds or as source extract.

In some embodiments, Hydroxycinnamic acid is obtained from any of cereals, fruits, vegetables, tea, coffee, wine, or any of its other natural or synthetic sources, in the form of Hydroxycinnamic acid or its derivatives, as isolated chemical compounds or as source extract.

In some embodiments, L-arginine is obtained from any of whole grains, nuts and seeds, legumes, dairy products, fish, poultry and other meats or any of its other natural or synthetic sources, in the form of L-arginine or its derivatives, as isolated chemical compounds or as source extract.

In some embodiments, HCA is present in ratio of moles of Kojic acid between 10:1 and 1:1000, preferably 3:100 and more preferably 1:10; wherein L-arginine is present in ratio of moles of Kojic acid between 20:1 and 1:500, preferably 3:70 and more preferably 1:5, where the composition exhibits an additional synergistic effect compared to individual components of the composition, for extending the shelf-life of the one or more mushrooms.

In some embodiments, the edible treatment composition includes an optional ingredient, and one or more optional additives of interest including any of active agents or inactive agents that serves purpose other than increasing the shelf-life of the mushrooms. In some embodiments, any of the additives increases the shelf-life of mushrooms. The one or more additives are selected from any of anti-microbial agents, anti-foaming agents, wetting agents, dispersing agents, nutraceutical agents, colouring agents, aromatics, flavorants, or others food additives.

In some embodiments, the edible treatment composition is water soluble/miscible. The edible treatment composition is in a form of a solid powder that can be dissolved in water or a liquid sprayable composition which is colourless, tasteless and/or odourless.

In some embodiments, at least one portion or all portions of the edible treatment composition are any of a plant extract or derived from a plant extract.

In another aspect, an embodiment herein provides a method of treating mushrooms with edible treatment composition for shelf-life extension of one or more mushrooms up to at least 3 days. The method includes mixing of Kojic acid in a range between about 0.001% (w/w) and about 0.1% (w/w), Hydroxycinnamic acid (HCA) in a range between about 0.0001% (w/w) and about 0.01% (w/w), and L-arginine in a range between about 0.0002% (w/w) and about 0.02% (w/w) to prepare the edible treatment composition. The method includes applying the edible treatment composition on the one or more mushrooms prior to, or after harvest of the one or more mushrooms, that facilitates shelf-life extension of the one or more mushrooms up to at least 3 days.

In some embodiments, the method includes applying the edible treatment composition on the one or more mushrooms by any of dipping, drenching, spraying, misting or brushing the one or more mushrooms with the edible treatment composition.

In some embodiments, the method includes treating the one or more mushrooms with the edible treatment composition for a period of time ranging from about 5 seconds to about 90 seconds for achieving shelf-life extension. The edible treatment composition is applied on the one or more mushrooms at least once or multiple times.

In some embodiments, excess aqueous composition on the one or more mushrooms post their treatment is reduced by using a drying process that minimizes thermo-shock to the one or more mushrooms.

In some embodiments, the method includes storing the one or more mushrooms treated with the edible treatment composition at any of low temperature or room temperature.

Accordingly, the present invention includes a variety of aspects or embodiments that may be selected in different combinations to suit the needs of a user. By addressing various factors responsible for low shelf-life of mushrooms, the factors that may normally cause physiological damage causing low shelf-life now may only cause a physical damage.

In some embodiments, the edible treatment composition is applicable to different mushroom species and varieties, including the ones having open veils (pileus). In yet another embodiment, the mushroom being treated is a white button mushroom or oyster mushroom.

In some embodiments, the edible treatment composition allows mushroom farms to retrofit the current system such that the time, effort and capital expenditures for its use are minimal without any extra equipment.

The edible treatment composition provides flexibility in the stage of mushroom treatment, pre-harvest or post-harvest, and also its mode of application. In some embodiments, the edible treatment composition used for shelf-life extension of fresh mushrooms is applied directly by spraying or misting it on the mushrooms before harvest and/or after harvest. The edible treatment composition used for shelf-life extension of fresh mushrooms is applied by dipping the fresh mushrooms in the edible treatment composition after harvest. The edible treatment composition may also be environmentally safe as the composition disclosed herein utilizes non-toxic and non-hazardous chemicals. Also, it serves as a work-safe method such that no special training is required for the preparation and utilization of the edible treatment composition.

The edible treatment composition used for extending shelf-life of mushrooms provides any of whiter, and/or firmer mushrooms without pileus opening for extended time that increases marketability and market value of the mushrooms. The treatment of mushrooms using the edible treatment composition may not demand additional treatment step, and can be incorporated in mushroom watering step itself. The mushroom treatment using the edible treatment composition does not require multiple treatment steps, thus minimising the number of different treatment steps. The treatment of mushrooms with the edible treatment composition renders a final value-added product, having improved organoleptic properties, and minimized impact of enzymatic processes like browning and ageing.

The description that follows more particularly exemplifies illustrative embodiments. In several places throughout this description, guidance is provided through lists of examples, that may be used in various combinations. In each instance, the recited list serves only as a representative group and should not be interpreted as an exclusive list. Thus, the scope of the present description should not be limited to the specific illustrative embodiments described herein, but rather extends at least to the structures described by the language of the claims, and the equivalents of those embodiments. Any of the elements that are positively recited in this description as alternatives may be explicitly included in the claims or excluded from the claims, in any combination as desired. Although various theories and possibilities have been discussed herein, in no event should such discussions serve to limit the claimable subject matter.

### BRIEF DESCRIPTION OF THE DRAWINGS

The embodiments herein will be better understood from the following detailed description with reference to the drawings, in which:

FIG. 1A illustrates an exemplary pictorial representation of non-treated mushrooms immediately after being harvested according to some embodiments herein;

FIG. 1B illustrates an exemplary pictorial representation of the mushrooms treated with edible treatment composition immediately after harvest according to some embodiments herein;

FIG. 2A illustrates an exemplary pictorial representation of non-treated mushrooms on day 3 after harvest according to some embodiments herein;

FIG. 2B illustrates an exemplary pictorial representation of the treated mushrooms on day 3 after harvest according to some embodiments herein; and

FIG. 3 illustrates graphical representation of average daily change in whiteness index for non-treated mushrooms and treated mushrooms according to some embodiment herein.

### DETAILED DESCRIPTION OF PREFERRED EMBODIMENTS

The present disclosure provides an edible treatment composition for shelf-life extension of mushrooms. Amongst other things, the present invention encompasses the edible treatment composition comprising of Kojic Acid which is an anti-yellowing and anti-browning agent, L-arginine which is an active agent inducing tissue firmness and preventing electrolyte leakage and HCA which is an anti-ageing activity agent. Certain desirable material and methods are described in more detail below. Compositions prepared in accordance with the present invention show superior ability to extend the shelf-life of mushrooms treated therewith, as compared to non-treated mushrooms. Furthermore, disclosed composition allows functional versatility in which additional agent/s, including active agents and inactive agents, can be incorporated to further improve the method or properties of the edible treatment composition. While not intending to be bound by theory, the composition disclosed herein can lead to improvement in shelf-life of treated mushrooms quite evident from improvement in one or more properties of treated mushrooms like, maintained whiteness, delayed browning, delated pileus (cap) opening, better firmness, slower weight-loss, amongst others.

Herein, the term “comprises” and variations thereof do not have a limiting meaning where these terms appear in the description and claims. Such terms will be understood to imply the inclusion of a stated step or component or group of steps or components but not the exclusion of any other step or component or group of steps or components. By “comprising of” is meant including, any components listed after the phrase, and limited to other components that do not interfere with or contribute to the activity or action specified in the disclosure for the listed components. Thus, the phrase “comprising of” indicates that the listed components are required or mandatory, but that other components are optional and may or may not be present depending upon whether or not they materially affect the activity or action of the listed components. Any of the components or combinations of components that are recited in this specification in open-ended language (e.g., consist/comprise and derivatives thereof), are considered to additionally be recited in closed-ended language (e.g., consist/comprise and derivatives thereof) and in partially closed-ended language (e.g., consist/comprise essentially, and derivatives thereof).

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other claims/embodiments are not useful, and is not intended to exclude other embodiments from the scope of the disclosure. In this application, terms such as “a”, “an”, and “the” are not intended to refer to only a singular entity, but include the general class of which a specific example may be used for illustration. The terms “a”, “an”, and “the” are used interchangeably with the term “at least one”. The phrases “at least one of” and “comprises at least one of” followed by a list refers to any one of the items in the list and any combination of two or more items in the list. As used herein, the term “or” is generally employed in its usual sense including “and/or” unless the content clearly dictates otherwise. The term “and/or” means one or all of the listed elements or a combination of any two or more of the listed elements.

Also herein, all numbers are assumed to be modified by the term “about” and in certain embodiments, preferably, by the term “exactly”. As used herein in connection with a measured quantity, the term “about” refers to that variation in the measured quantity as would be expected by the person skilled in art making the measurement and exercising a level of care commensurate with the objective of the measurement and the precision of the measuring equipment used. Herein, “upto” a number (e.g., up to 0.001) includes the number (e.g., 0.001). The term “in the range” or “within a range” (and similar statements) includes the endpoints of the stated range.

In an embodiment herein, the term “Substantially free” as used may imply that it is absent or present at a concentration that is either (i) below detection levels for any art-accepted means; or, (ii) has no or little impact on downstream application, such that it is considered negligible.

Also herein, the recitations of numerical ranges by endpoints include all numbers subsumed within that range as well as the endpoints and all subranges (e.g., 1 to 5 includes 1, 1.5, 2, 2.75, 3, 3.80, 4.99, 5, etc. as well as 2 to 5, 1 to 4, 2 to 4, 1.5 to 3, etc.).

Reference throughout this specification to “one embodiment”, “an embodiment”, “certain embodiments”, or “some embodiments”, etc., means that a particular feature, configuration, composition, or characteristic described in connection with the embodiment is included in at least one embodiment of the disclosure. Thus, the appearances of such phrases in various places throughout this specification are not necessarily referring to the same embodiment of the disclosure. Furthermore, the particular features, configurations, compositions, or characteristics may be combined in any suitable manner in one or more embodiments. The basic concepts of the present invention may be embodied in a variety of ways.

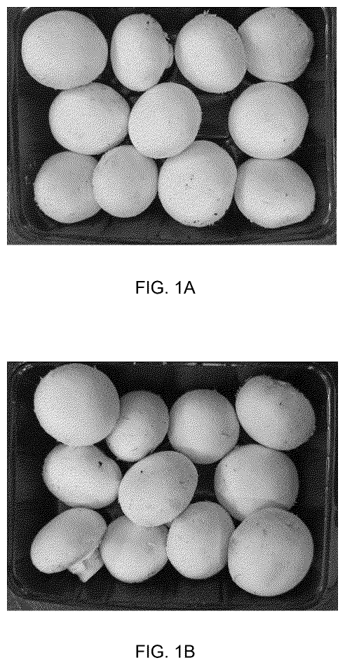

FIG. 1A illustrates an exemplary pictorial representation of non-treated mushrooms immediately after being harvested according to some embodiments herein. FIG. 1B illustrates an exemplary pictorial representation of the mushrooms treated with an edible treatment composition immediately after harvest according to some embodiments herein.

The edible treatment composition includes at least one anti-yellowing and anti-browning agent. The at least one anti-yellowing and anti-browning agent is preferably Kojic acid. Without intending to be bound by any theory, Kojic acid is known to function via two different mechanisms in tyrosinase inhibition action: firstly in a non-competitive manner by interrupting Enzyme-Substrate-Inhibitor complex and secondly in a competitive manner by forming Enzyme-Inhibitor (EI) complex. Tests are carried out on mushrooms with different concentrations of Kojic acid that showed mushrooms treated with Kojic acid display better whiteness properties, such that the whiteness of treated mushrooms is maintained for a longer period as compared to non-treated mushrooms which turn brown very fast. Here, the term “white” is used to describe a colour generally naturally associated with fresh mushrooms while the term “brown” is used to describe a colour generally associated with degradation of mushrooms. The concentration of Kojic acid used in the edible treatment composition may vary and any concentration of Kojic acid, within the set safety limit may provide desired results. In some embodiments, any other anti-yellowing and anti-browning agent suitable for consumption can be used in combination with Kojic acid. As used in the context of the present disclosure, the terms “anti-yellowing and anti-browning agent” and “browning inhibitor” are used interchangeably herein and are understood to mean any substance added to the treatment composition to delay or inhibit altogether the browning of mushroom and maintain its whiteness for longer period.

The edible treatment composition includes at least one anti-ageing activity agent. The at least one anti-ageing activity agent is preferably Hydroxycinnamic acid (HCA). For example, the use of HCA may be beneficial to improve shelf-life extension properties of the edible treatment composition. HCA is capable of improving shelf-life of mushrooms by delaying its ageing, and thus delaying its cap/pileus opening. Tests are carried out on mushrooms with different concentrations of HCA that showed mushrooms treated with HCA display slower rate of ageing and delayed pileus opening as compared to non-treated mushrooms. The edible treatment composition may include any suitable amount of HCA to achieve the desired result. In some embodiments, any other anti-ageing active agent suitable for consumption can be used in combination with HCA.

The edible treatment composition includes L-Arginine. Without intending to be bound by any theory, L-Arginine is known to effectively control tissue softening and maintain tissue firmness in mushroom which in turn helps to reduce electrolyte leakage and rapid dehydration of the mushroom surface. Also, L-Arginine is the immediate precursor of nitric oxide, which helps delay the browning of mushroom surface. L-Arginine is capable of improving shelf-life of mushroom by effectively controlling tissue softening, maintaining tissue firmness and consequently reducing electrolytic leakage. In some embodiments, mushrooms treated with L-Arginine have a whiter surface and firmer fruit body for extended time as compared to non-treated mushrooms.

The edible treatment composition for shelf-life extension of the one or more mushrooms up to at least 3 days, includes a combination of Kojic acid, L-arginine and HCA. In some embodiments, the edible treatment composition includes Kojic acid in a range between about 0.001% (w/w) and about 0.1% (w/w), L-arginine in a range between about 0.0002% (w/w) and about 0.02% (w/w), and HCA in a range between about 0.0001% (w/w) to about 0.01% (w/w). Many combinations of Kojic acid, L-arginine and HCA may be possible, including a combination of at least two of those three components. The edible treatment composition includes a mixture of Kojic acid, HCA, and L-arginine that is applied on the one or more mushrooms by any of dipping, drenching, spraying, misting or brushing the edible treatment composition over the one or more mushrooms, that facilitates shelf-life extension of the one or more mushrooms up to at least 3 days.

The Kojic acid may be obtained from any of soy sauce, rice wine, fungal species of Aspergillus, or any of its other natural or synthetic sources, in the form of Kojic acid or its derivatives, as isolated chemical compounds or as source extract. The HCA may be obtained from any of cereals, fruits, vegetables, tea, coffee, wine, or any of its other natural or synthetic sources, in the form of Hydroxycinnamic acid or its derivatives, as isolated chemical compounds or as source extract. The L-arginine may be obtained from any of whole grains, nuts and seeds, legumes, dairy products, fish, poultry and other meats or any of its other natural or synthetic sources, in the form of L-arginine or its derivatives, as isolated chemical compounds or as source extract.

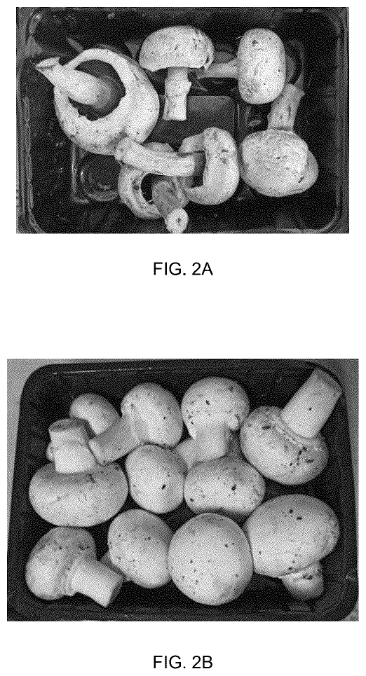

FIG. 2A illustrates an exemplary pictorial representation of non-treated mushrooms on day 3 after harvest according to some embodiments herein. FIG. 2B illustrates an exemplary pictorial representation of the treated mushrooms on day 3 after harvest according to some embodiments herein. The edible treatment composition as a whole, may display superiority over any of its individual components stand-alone, which is reinforced by data manifesting benefits of treatment by the edible treatment composition on mushrooms.

In some embodiments, the edible treatment composition includes one or more optional additives of interest that do not adversely affect the edible treatment composition or activity of any of its active components. The one or more optional additives may be any of active agents or inactive agents and are typically included in the edible treatment composition to improve particular functional property of composition, facilitate processing, enhance nutritional composition, enhance aesthetics, enhance flavour or odour of the composition or treated mushrooms. Non limiting examples of such additives that may be included in the edible treatment composition includes one or more anti-microbial agents, anti-foaming agents, wetting agents, dispersing agents, nutraceutical agents, colouring agents, aromatics, flavorants, and/or others food additives.

In some embodiments, the edible treatment composition includes one or more anti-microbial agents to enhance mushroom shelf-life extension properties. Examples of anti-microbial agents include, but are not limited to Hydrogen per-oxide, ascorbic acid, citric acid, sodium metabisulphide, calcium metabisulphide, sodium hypochlorite, calcium hypochlorite, etc. or a combination thereof. Any anti-microbial agent safe for human consumption or listed as GRAS for indirect or direct food contact or consumption may be made use of. Such anti-microbial agents, when used, are in concentration ranges that are not per se toxic, and their concentrations may vary depending on the particular anti-microbial agents being used. In some embodiments, (i) the anti-foaming agent can be Polydimethylsiloxane, (ii) wetting agent or dispersing agent can be Propylene glycol, (iii) nutraceutical agents can be Citrus Bioflavonoids, Caffeine, Chlorella vulgaris i.e. dried powder Green algae, (iv) colouring agents can be Carotene and Carotenoids, (iv) aromatics can be aromatic herbs including cloves, and cumin herbs, and (v) flavorants can be Ethyl propionate.

In some embodiments, these additives may be added in the edible treatment composition prior to applying the edible treatment composition on mushrooms. Alternatively, mushrooms may be treated with such additives after being treated with edible treatment composition. However, care must be taken so as not to adversely affect the desired properties of the edible treatment composition.

In some embodiments, compounds used as active agents and additives can be obtained as lab grade chemicals; moreover, in other embodiments, the compounds used as active agents and additives can be obtained as industrial food grade chemicals that are commercially available.

The edible treatment composition may be used as a treatment agent to slow down degradation of mushrooms, which is otherwise very rapid, thus increasing its shelf-life. The edible treatment composition may significantly extend the shelf-life of mushrooms treated therewith. The term “shelf-life” usually signifies maximum duration of time for which mushroom may be stored, during which its defined quality remains acceptable, without becoming unapt for consumption. A number of parameters can be studied, by any suitable means, to assess the quality and freshness of mushroom before and after or during storage to measure relative efficacy of shelf-life extension. These parameters may include, but are not limited to, water loss, which is reflected in weight loss; colour change, be it overall shading or local spotting; ageing, that is reflected as mushroom pileus opening; textural changes like scaling; structural integrity or change in shape and firmness; changes in odour, taste or chemical species; changes in respiration and gas exchange rates, etc. Non-limiting examples of selected parameters studied are provided in the exemplification below.

Without wishing to be bound by any theory, treatment of mushrooms by the edible treatment composition may be able to maintain whiteness of mushrooms, for a longer period of time as compared to the non-treated mushrooms.

Without wishing to be bound by any theory, treatment of mushrooms by the edible treatment composition may be able to delay pileus opening of mushrooms for a longer period of time as compared to the non-treated mushrooms.

In some embodiments, the edible treatment composition extends the shelf-life of mushrooms treated therewith, as compared to the mushrooms without the described treatment, when both, the treated and non-treated, mushrooms are processed and stored otherwise under identical or substantially identical conditions. With the use of the edible treatment composition, in some embodiments, the shelf-life of mushrooms is extended by between about 1.1 and about 2.5 fold, as compared to the non-treated mushrooms e.g., about 1.2, about 1.3, about 1.4, about 1.5, about 1.6, about 1.7, about 1.8, about 1.9, about 2.0, about 2.1, about 2.2, about 2.3, about 2.4, and about 2.5 fold. In some embodiments, the shelf-life of mushrooms can be extended up to at least 3 days with the edible treatment composition.

In some embodiments, the treatment of mushrooms can be carried out by dipping the mushrooms in the edible treatment composition. The treatment may be carried out by spraying the edible treatment composition over the mushrooms to be treated. In some embodiments, any suitable technique can be used for treatment step, including but not limited to dipping, drenching, spraying, misting, brushing and the like and/or different combinations thereof.

In some embodiments, the edible treatment composition can be employed for treatment of mushrooms before or after harvest of mushrooms. In some embodiments, for instance, the mushrooms can be treated with the edible treatment composition while it is still growing. The edible treatment composition may be incorporated in one or more of the watering cycles given to the mushroom throughout its growth. In yet another embodiment, for instance, the mushroom may be treated with the edible treatment composition after its harvest. It is customary to wash mushrooms prior to being shipped to remove adhering compost, casing material and other unwanted particulate material. The edible treatment composition of the present disclosure may be incorporated in such a washing step.

In some embodiments, mushrooms can be treated by the edible treatment composition such that at least one portion of mushroom is exposed to the edible treatment composition. Treatment of mushroom by dipping method is typical as it facilitates overall treatment of all mushroom surfaces simultaneously in a uniform manner such that all the surfaces of mushroom are exposed to the edible treatment composition equally and for equal time period. Dip time for mushroom in the edible treatment composition may be dependent upon different factors like size of mushrooms, concentration of treatment solution, amongst others. Accordingly, mushrooms may be dipped in the edible treatment composition for a period of time ranging from about 5 second to about 90 seconds, and more specifically for a period of time ranging from about 10 seconds to about 60 seconds, and even more specifically from about 15 seconds to about 45 seconds. For example, the dip time may be less than about 90 seconds, but more than 5 seconds.

In some embodiments, efficacies of active compound combinations can be determined using Colby's generalized approach formula from “Prediction of synergistic multi-compound mixtures-A generalized Colby approach” by H. Soller, A, Wedemeier, and compared with the observed efficacies. Colby's generalized approach formula:

$$CE = ( x + y + z ) - \frac{x \cdot y + y \cdot z + x \cdot z}{100} + \frac{x \cdot y \cdot z}{10000}$$

where, CE is expected/calculated efficacy, expressed in % of the non-treated control, when using the mixture of the active compounds A, B and C at the concentrations a, b and c; x is efficacy, expressed in % of the non-treated control mushroom, when using the active compound A at the concentration a; y is efficacy, expressed in % of the non-treated control mushroom, when using the active compound B at the concentration b; z is efficacy, expressed in % of the non-treated control mushroom, when using the active compound C at the concentration c;

Efficacies x, y and z of individual components can be calculated as

$$efficacy = \frac{p - q}{p} \times 100$$

In one embodiment, p corresponds to difference in the L* value of non-treated control mushroom over the period of three days; and q corresponds to difference in the L* value of respective component treated mushroom over the period of three days. In another embodiment, p corresponds to difference in the degree of cap opening value of non-treated control mushroom over the period of three days; and q corresponds to difference in the degree of cap opening value of respective component treated mushroom over the period of three days.

If the observed efficacy of the combination exceeds the expected/calculated efficacy of the combination, and the resulting synergy factor [(Observed efficacy)-(Calculated efficacy)] is thus >1, the combination of the active components is said to exhibit synergistic effect.

In example 1, the edible treatment composition includes solubilizing a predetermined quantity of Kojic acid in water to obtain concentrate Kojic acid solution. Similarly, predetermined quantities of HCA and L-arginine are dissolved separately in water to obtain concentrate HCA and concentrate L-arginine solutions respectively. Concentrate Kojic acid solution is then gradually added to concentrate HCA solution under constant stirring condition at room temperature and atmospheric pressure. The volume of concentrate Kojic acid solution added to concentrate HCA solution is such that the concentration ratio of Kojic acid to HCA is maintained at 10:1 in the final composition. To the resulting Kojic acid and HCA mixture, predetermined volume of concentrate L-arginine solution is added under constant stirring condition at room temperature and atmospheric pressure. The volume of concentrate L-arginine solution added to Kojic acid and HCA mixture is such that the concentration ratio of Kojic acid to L-arginine is maintained at 10:2 in the final composition. The resulting final edible treatment composition solution is maintained at room temperature throughout the treatment procedure. All chemicals and reagents in the exemplary embodiments are used without further purification unless specified otherwise. All processes are carried out at room temperature and atmospheric pressure unless stated otherwise. The variety of mushrooms used in exemplary embodiments is white button mushroom unless specified otherwise. All the solution concentrations are to be considered in terms of weight percentage (wt. %) unless stated otherwise.

In example 2, mushrooms are procured directly from the mushroom fields freshly after harvest. The mushrooms were not treated with any insecticide, pesticide or any other chemical as such during its growth or after its harvest. Mushrooms are weighed and sorted according to size for uniform sampling. Mushrooms are thereafter treated by dipping them in dip tank containing liquid solution of edible treatment composition prepared in the above-mentioned example 1. Total dip time given to mushrooms is 30 seconds, after which the mushrooms are removed from the tank and held on conveyor belt for 10 seconds to allow excess solution to drain, followed immediately by damp drying on paper tissue or towel and promptly storing at 4° C. The mushrooms are then removed from the cold storage after 24 hours and stored at ambient room conditions for the entire duration of the time for which they are tested. No visible residue or precipitate is observed on the treated mushrooms.

In example 3, mushrooms are treated pre-harvest. In order to do so, the mushrooms are spray treated in the following manner. During one of the watering cycles for mushrooms, the edible treatment composition from the example 1 is added to the water to be employed for watering cycle itself in a definite quantity so as to achieve treatment composition of desired concentration. The solution thus formed is passed through a nozzle to generate fine mist spray. The spray head is held approximately 20 centimetres from the mushrooms, and the mushrooms are spray treated and then allowed to dry at ambient conditions without need for damp drying. Immediately after harvest, treated mushrooms are stored at 4° C. for 24 hours. The mushrooms are then removed from the cold storage and stored at ambient room conditions for the entire duration of the time for which they are tested. No visible residue or precipitate is observed on treated mushrooms.

In example 4, the stored mushrooms from the example 3 are evaluated for degree of whiteness over a period of three days, viz. day 1, 2 and 3. Mushrooms are stored at ambient conditions of room temperature which represent physiologically stressful conditions so as to illustrate advantages of treatment to a greater extent as compared to controlled low temperatures. In this test for evaluation of degree of whiteness, analysis is done for 6-12 mushrooms each of non-treated and treated mushrooms for their visible time dependant variance in shading from the original white colour to unacceptable brown colour. The degree of whiteness of mushrooms is evaluated in terms of L* value. Higher L* values suggests better whiteness.

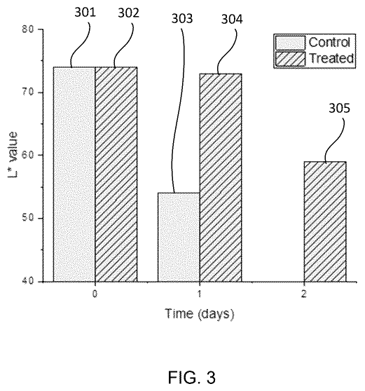

FIG. 3 illustrates a graphical representation of average daily change in whiteness index for non-treated mushrooms and treated mushrooms according to some embodiments herein. Each bar in the graphical representation indicates average daily change in whiteness index for a group of 6-12 mushrooms. The mushrooms corresponding to bar 301 and 303 are non-treated mushrooms on day 1 and day 2 respectively. The mushrooms corresponding to bar 302, 304 and 305 are treated mushrooms on day 1, day 2 and day 3 respectively. Those categories for which a rating is not given, indicates an unacceptable L* value for mushroom from wholesale or consumer levels' views. L* value of both, the non-treated and the treated mushrooms decreases with the storage time; although a considerable difference in rate of L* value decrease is observed between the two groups. While the non-treated mushrooms display a rapid decrease in L* value, the treated ones display a much slower rate. The L* value in the non-treated mushrooms sharply decrease form 74 on day 1 to 54 on day 2 and finally reaching an unacceptable value for mushroom on day 3. However, the L* value in treated samples are maintained at 73 on day 2 and decrease to 59 on day 3. Mushroom with L* values <45 are considered as unacceptable from a whiteness point of view at wholesale or consumer levels respectively.

In example 5, the stored mushrooms from the example 3 and example 4 are evaluated for degree of whiteness for mushrooms treated with individual active components viz. Kojic acid, L-arginine and HCA, and their combination, over a period of three days, according to some embodiments herein. The activities of the individual components and that of synergistic combination, calculated from the difference in L* values of the treated and non-treated control mushrooms, are converted into efficacies. An efficacy of 0 means that the anti-browning and anti-yellowing, activity corresponds to that of non-treated control mushroom, while an efficacy of 100 corresponds to absolutely no change in whiteness of mushroom as compared to that on Day 1. Following Table shows the test results, where the expected efficacies of the combination of the active components are determined using Colby's generalized approach formula.

| | | L* value | | | | | | Synergy |
|---|---|---|---|---|---|---|---|---|
| | Concentration | Day | Day | | Observed | Calculated | Synergism | factor |
| Treatment | (%) | 1 | 3 | Difference | Efficacy | Efficacy | (%) | (OE/CE) |
| Non-treated | — | 74 | 44 | 30 | 0 | | | |
| Control | | | | | | | | |
| HCA | 0.016 | 74 | 47 | 27 | 10.00 | | | |
| Kojic acid | 0.016 | 74 | 51 | 23 | 23.33 | | | |
| L-arginine | 0.016 | 74 | 46 | 28 | 6.67 | | | |
| Combination | 0.016 | 74 | 59 | 15 | 50.00 | 35.60 | 14.40 | 1.40 |

From the above example, the combination of Kojic acid which has anti-tyrosinase activity, with L-arginine and HCA exhibits a synergistic anti-browning and anti-yellowing effect, can be observed. Effectiveness of the synergistic mixture or combination is higher than the sum of the effective activities of the individual components in isolation, and a synergy factor obtained is above 1.

In example 6, the stored mushrooms from the example 3 are evaluated for their rate of ageing in terms of degree of cap (pileus) opening over a period of three days, viz. day 1, 2, and 3. The mushrooms are stored at ambient conditions of room temperature which represent physiologically stressful conditions so as to illustrate advantages of treatment to a greater extent as compared to controlled low temperatures. In this test for evaluation of rate of ageing, analysis is done for 6-12 mushrooms each of non-treated and treated mushrooms for their visible time dependant variance in degree of cap opening from the original completely closed cap (pileus) to unacceptable completely open cap (pileus). The degree of cap (pileus) opening of mushrooms are evaluated on a scale of 1 to 10, where a score of 1 suggests completely open mushroom cap (pileus) indicating highly mature and aged mushrooms whereas a score of 10 suggests completely closed cap (pileus) indicating fresh and intact mushroom.

From the FIGS. 1A to 2B, it is clear that the degree of cap (pileus) opening values in both, the non-treated and the treated mushrooms decrease with the storage time; although a considerable difference in extent of decrease is observed between the two groups. The degree of cap (pileus) opening value in the non-treated samples sharply decrease form 10 on day 1 to 2 on day 3. However, the degree of cap (pileus) opening value in treated samples is maintained at 9 on day 3. Mushrooms with degree of cap (pileus) opening values <5 are considered to be unacceptable from maturity and ageing point of view at wholesale or consumer levels respectively.

In example 7, the stored mushroom in the example 3 and example 6 are evaluated for their rate of ageing in terms of degree of cap opening for mushrooms treated with individual active components viz. Hydroxycinnamic acid (HCA), L-arginine and Kojic acid and their combination, over a period of three days, according to some embodiments herein. The activities of the individual components and that of synergistic combination, calculated from the difference in degree of cap opening values of the treated and non-treated control mushrooms, are converted into efficacies. An efficacy of 0 means that the degree of cap opening corresponds to that of non-treated control; while an efficacy of 100 corresponds to absolutely no change in degree of cap opening of mushroom as compared to that on Day 1. Following table shows the test results, where the expected efficacies of the combination of the active components are determined using Colby's generalized approach formula.

| | | Degree of cap opening | | | | | | Synergy |
|---|---|---|---|---|---|---|---|---|
| | Concentration | Day | Day | | Observed | Calculated | Synergism | factor |
| Treatment | (%) | 1 | 3 | Difference | Efficacy | Efficacy | (%) | (OE/CE) |
| Non-treated | — | 10 | 2 | 8 | 0 | | | |
| Control | | | | | | | | |
| HCA | 0.016 | 10 | 6 | 4 | 50 | | | |
| L-arginine | 0.016 | 10 | 5 | 5 | 37.5 | | | |
| Kojic acid | 0.016 | 10 | 2 | 8 | 0 | | | |
| Combination | 0.016 | 10 | 9 | 1 | 87.5 | 68.75 | 18.75 | 1.27 |

From the above example, the combination of Hydroxycinnamic acid which has anti-ageing activity, with L-arginine and Kojic acid exhibits a synergistic anti-ageing and delayed cap-opening effectiveness, can be observed. Effectiveness of the synergistic mixture or combination is higher than the sum of the effective activities of the individual components in isolation and a synergy factor obtained is above 1.

Higher degree of whiteness, L* values, indicating effective anti-browning and lower degree of cap (pileus) opening values indicating slower ageing and maturity rate in treated mushrooms as compared to non-treated mushrooms indicate benefits of the edible treatment composition, especially under stressful conditions of temperature. Moreover, the edible treatment composition, as a whole, displays superiority over any of its individual components stand-alone; which is reinforced by the data manifesting benefits of treatment of mushrooms by disclosed edible treatment composition.

In some embodiments, Kojic acid, L-Arginine and HCA exhibit synergistic anti-browning, anti-yellowing and delayed cap-opening effects when applied in combination. These combinations can be found to possess improved efficacy of enhanced anti-browning, anti-yellowing, and anti-ageing activities.

In case of mushroom, it is desirable to minimise its exposure to relatively high temperatures during treatment process. The average solution temperature during treatment of mushroom with edible treatment composition may be ambient temperature; this provides high feasibility in treatment process, in contrast to many other processes in the prior art that require much difficult to achieve higher temperatures to be effective, like for example alkali hypochlorite solution or borax solution.

A short period of time required for treatment of mushrooms with edible treatment composition disclosed herein makes it suitable for rapid treatment and is advantageous for treating large volumes of mushroom such as, for instance, on an industrial scale.

In some embodiments, mushrooms may be treated once or multiple times with the edible treatment composition disclosed herein. Between or following each or one of the treatment steps, the mushroom may be subjected to drying.

Post-harvest dip treatment of mushroom facilitates uniform and overall treatment of mushrooms; however, high moisture content on mushroom after treatment tends subjection of treated mushrooms to microbial proliferation and may reduce the effectiveness of treatment.

Excessive water on mushroom surface may be detrimental to quality of mushroom. In some embodiments, the moisture content on mushrooms after treatment is reduced by damp drying the mushrooms using a suitable drying process that minimizes thermos-shock to the mushrooms. In some embodiments, drying can be achieved by mechanical means like, for example, swabbing or dabbing with an absorbent surface like paper tissue, fabric or towel or other suitable absorbents. In some embodiments, post treatment drying of mushrooms can be achieved by means of evaporation under ambient conditions of temperature and pressure, without relying on increased temperatures. In some embodiments, drying can be achieved by blowing air over the treated mushroom. More sophisticated techniques like use of air knife, vacuum drying, desiccation, surface lyophilisation, etc. can also be employed in drying process. In some embodiments, techniques such as centrifugal drying may be avoided to prevent mechanical damage to mushrooms during drying process. The reduction of moisture content on mushroom post-treatment makes it less susceptible to microbial proliferation, which in turn tends to extend the shelf-life of the treated mushroom. In some embodiments, the treatment of mushrooms with the edible treatment composition is done before its harvest, wherein no such drying process/step is needed. The treatment of mushrooms with the edible treatment composition may or may not be followed by a drying step.

In some embodiments, after being treated with the edible treatment composition, mushrooms can be stock-stored at temperatures ranging from 2° C. up to 15° C. It may be preferable to maintain temperature of mushroom at around 4° C. for at least 12 to 24 hours after being treated with the edible treatment composition to reduce its susceptibility to enzymatic activity triggering at higher temperatures. In some embodiments, the edible treatment composition facilitates treated mushrooms, that may or may not be pre-cooled, to be kept fresh for longer period of time even in the absence of refrigeration.

Treatment of mushrooms with the edible treatment composition may reduce, or eliminate altogether, the typical need for conventional cold chain. In some embodiments, for example, mushrooms, that are typically stored and/or shipped at certain preferred temperature ranges, may be able to maintain their quality in terms of one or more parameters within and beyond such temperature ranges when treated with the edible treatment composition. In some embodiments, mushrooms treated with the edible treatment composition can withstand greater degree of fluctuations and/or deviations in temperature, light exposure, mechanical stress, moisture, or combination thereof.

Transparency of treatment material is a desirable feature for maintaining the natural colour and/or appearance of the mushrooms. In some embodiments, mushrooms when treated with the edible treatment composition, will not be negatively perceptible as ‘treated’ to consumer via one or more, and preferably all, relevant senses like appearance, touch, smell, or taste. Moreover, the edible treatment composition does not leave the treated mushroom with a slippery, sticky or tacky feel but rather the treated mushroom has a tactile surface feel that is similar to that of the non-treated mushroom. Nonetheless, treatment with the edible treatment composition may have an added effect of shine and brightness on the mushroom thus making it more aesthetically pleasing. For edible embodiments in which the treated mushrooms will likely be consumed without washing, edible treatment composition described herein typically does not have a perceptible flavour/taste, odour, or both.

In some embodiments, the edible treatment composition is sufficiently water-soluble and therefore is easily washable with water from treated mushroom surfaces.

Nonetheless, in some embodiments, removal of edible treatment composition from the treated mushrooms before consumption may not be needed. The edible treatment composition allows mushroom farms to retrofit current system such that the time, effort and capital expenditures for its use are minimal. In some embodiments, the edible treatment composition is applicable to different commercially important mushroom species and varieties, including the ones having open veils (pileus). In yet another embodiment, the mushroom being treated is a white button mushroom or oyster mushroom or any other type of mushroom.

In some embodiments, the edible treatment composition is typically in liquid form when applied to the mushrooms. A suitable solvent, preferably water, can be used as carrier for the composition. Water-based compositions are preferred because of its reduced cost, ease of handling and application, and low or no flammability risk, amongst others. Alternatively, the edible treatment composition may be provided in a dry solid form like for example, fine powdered, particulates or tablet form. In such embodiments, the solid concentrate is capable of forming a liquid solution of edible treatment composition when combined with a liquid carrier, prior to its application on mushrooms. The edible treatment composition may also be provided as a liquid concentrate that is diluted prior to its application on mushroom via addition of liquid carrier (e.g. water). Without wishing to be bound by theory, while the solid composition can be highly soluble, the liquid treatment solution can include suspended or dispersed particles, residue, or precipitate without adversely affecting the effectiveness of the edible treatment composition.

Treatment of mushrooms with the edible treatment composition renders a final value-added mushroom with extended shelf-life facilitating farmers and vendors to have better marketability as compared to non-treated ones, and also facilitate consumers to have more flexibility in buying and consumption times. In some edible embodiments, the edible treatment composition complies with Food Safety and Standards Authority of India (FSSAI) labelling requirements and can be labelled as safe to consume.

Having generally described the invention, the disclosure is further illustrated by reference to certain specific examples which are provided herein for the purpose of illustration only and are not to be construed as limiting this disclosure in scope or spirit to the specific procedures and embodiments herein described unless otherwise specified. It is to be understood that the examples are provided to illustrate certain embodiments and that no limitation to the scope of the disclosure is intended thereby. It is to be further understood that resort may be had to various other embodiments, modifications, and equivalents thereof which may suggest themselves to those skilled in the art without departing from the spirit of the present disclosure and/or scope of the appended claims.

I/We claim:

1. An edible treatment composition for shelf-life extension of one or more mushrooms up to at least 3 days, wherein the edible treatment composition comprises,
Kojic acid in a range between about 0.001% (w/w) and about 0.1% (w/w);
Hydroxycinnamic acid (HCA) in a range between about 0.0001% (w/w) and about 0.01% (w/w); and
L-arginine in a range between about 0.0002% (w/w) and about 0.02% (w/w),
wherein the edible treatment composition comprising a mixture of Kojic acid, HCA, and L-arginine is applied on the one or more mushrooms by any of dipping, drenching, spraying, misting or brushing the edible treatment composition over the one or more mushrooms, that facilitates shelf-life extension of the one or more mushrooms up to at least 3 days.

2. The edible treatment composition as claimed in claim 1, wherein the Kojic acid is obtained from any of soy sauce, rice wine, fungal species of Aspergillus.

3. The edible treatment composition as claimed in claim 1, wherein Hydroxycinnamic acid is obtained from any of cereals, fruits, vegetables, tea, coffee, wine.

4. The edible treatment composition as claimed in claim 1, wherein L-arginine is obtained from any of whole grains, nuts and seeds, legumes, dairy products, fish, poultry and other meats.

5. The edible treatment composition as claimed in claim 1, wherein HCA is present in ratio of moles of Kojic acid between 10:1 and 1:1000, preferably 3:100 and more preferably 1:10; wherein L-arginine is present in ratio of moles of Kojic acid between 20:1 and 1:500, preferably 3:70 and more preferably 1:5.

6. The edible treatment composition as claimed in claim 1, wherein the edible treatment composition comprises an optional ingredient, and one or more additives of interest comprising any of active agents or inactive agents, wherein the one or more additives are selected from any of anti-microbial agents, anti-foaming agents, wetting agents, dispersing agents, nutraceutical agents, colouring agents, aromatics, flavorants, or others food additives.

7. The edible treatment composition as claimed in claim 1, wherein the edible treatment composition is water soluble/miscible, wherein the edible treatment composition is in a form of a solid powder that can be dissolved in water or a liquid sprayable composition which is colourless, tasteless and/or odourless.

8. The edible treatment composition as claimed in claim 1, wherein at least one portion or all portions of the edible treatment composition are any of a plant extract or derived from a plant extract.

9. A method for treating mushrooms with edible treatment composition for shelf-life extension of one or more mushrooms up to at least 3 days, wherein the method comprises,
mixing of Kojic acid in a range between about 0.001% (w/w) and about 0.1% (w/w), Hydroxycinnamic acid (HCA) in a range between about 0.0001% (w/w) and about 0.01% (w/w), and L-arginine in a range between about 0.0002% (w/w) and about 0.02% (w/w) to prepare the edible treatment composition; and
applying the edible treatment composition on the one or more mushrooms prior to, or after harvest of the one or more mushrooms, that facilitates shelf-life extension of the one or more mushrooms up to at least 3 days.

10. The method as claimed in claim 9, wherein the method comprises,
applying the edible treatment composition on the one or more mushrooms by any of dipping, drenching, spraying, misting or brushing the one or more mushrooms with the edible treatment composition.

11. The method as claimed in claim 9, wherein the method comprises,
treating the one or more mushrooms with the edible treatment composition for a period of time ranging from about 5 seconds to about 90 seconds for achieving shelf-life extension, wherein the one or more mushrooms are treated with the edible treatment composition at least once or multiple times.

12. The method as claimed in claim 9, wherein excess aqueous composition on the one or more mushrooms post their treatment is reduced by using a drying process that minimizes thermo-shock to the one or more mushrooms.

13. The method as claimed in claim 9, wherein the method comprises,
storing the one or more mushrooms treated with the edible treatment composition at any of low temperature or room temperature.
